(19) United States
(12) Patent Application Publication
(10) Pub. No.: US 2023/0243753 A1
(43) Pub. Date: Aug. 3, 2023

(54) HANDHELD LIBS DEVICE WITH ATMOSPHERIC PURGE

(71) Applicant: SciAps, Inc., Woburn, MA (US)

(72) Inventor: David Day, Boxford, MA (US)

(21) Appl. No.: 18/156,464

(22) Filed: Jan. 19, 2023

Related U.S. Application Data
(60) Provisional application No. 63/306,152, filed on Feb. 3, 2022.

(51) Int. Cl. G01N 21/71

(52) U.S. Cl. CPC G01N 21/718; G01N 2201/0221; G01N 2201/0235

(57) ABSTRACT

A handheld LIES device includes a laser source for generating a laser beam, a spectrometer subsystem for analyzing a plasma generated when the laser beam strikes a sample, and a nose section including an end plate with an aperture for the laser beam and for receiving plasma radiation and an optic spaced from the end plate defining with the end plate a cavity therebetween. An atmospheric purge subsystem includes an air pump with an intake exposed to the atmosphere and a conduit connected to the air pump providing an atmospheric gas mixture to the nose section cavity to purge the cavity of contaminants and keep the optic clean as the atmospheric gas mixture exits the cavity through the end plate aperture.

### RELATED APPLICATIONS

This application claims benefit of and priority to U.S. Provisional Application Ser. No. 63/306,152 filed Feb. 3, 2022 under 35 U.S.C. §§ 119, 120, 363, 365, and 37 C.F.R. § 1.55 and § 1.78, which is incorporated herein by this reference.

### FIELD OF THE INVENTION

This subject invention relates to laser induced breakdown spectroscopy (LIBS) devices.

### BACKGROUND OF THE INVENTION

LIBS devices are known and used to detect elemental concentration of many elements with some accuracy. These devices typically include a laser that sufficiently heats a portion of a sample to produce a plasma. Photons are emitted at wavelengths unique to the specific elements comprising the sample. A spectrometer subsystem detects the photons and is able to analyze which elements are present in the sample and at what concentration.

Argon is often used to purge the LIBS plasma region to enhance signal which results from its reduced thermal conductivity relative to air. Typically, the flow rate is high and the area purged is large. The gas may be used to purge a sample chamber in some prior art LIBS analysis systems. Accordingly, a large source (e.g., a tank) of argon gas may be required and must be towed along in the field. See U.S. Pat. Nos. 9,395,243; 6,700,660; 7,916,834; 10,718,716; 7,821,634; and 10,677,733 all incorporated herein by this reference.

For some handheld LIBS devices, argon or other inert gas purge subsystems are often used with small gas canisters and a regulator fluidly connected to the argon canister and providing argon gas to the plasma site. See, for example, U.S. Pat. No. 10,883,921 and published U.S. Application No. 2008/0192897, both incorporated herein by this reference.

The small gas canister may need to be replaced often. And, the argon gas is expensive as is the argon regulator used to provide the argon gas to the plasma site.

### BRIEF SUMMARY OF THE INVENTION

Argon is often used to purge the plasma region during LIBS measurements. An argon purge may have the advantage of enhancing signal and carrying away sputtered sample material which can contaminate internal optics. Some customers/users may desire a handheld LIBS unit which does not require replacement of the argon canister and/or which does not include an expensive argon regulator. While argon usage usually enhances the LIBS signal, there are many applications where the signal is adequate without its use. However, without gas flow, the LIBS laser typically produces sputtered sample material which can accumulate on surfaces surrounding the plasma. Handheld LIBS instruments typically include a protective barrier optic to prevent this “dirt” and contamination from entering the inner parts of the instrument. This barrier might be a clear optic (“splatter shield”) that can pass the outgoing laser light as well as the returning elemental emission wavelengths, or it might be the actual focusing elements sealed in barrier wall. In either case, a buildup of sputtered sample material will eventually occur and the barrier optic(s) will require cleaning. Otherwise, the dirty barrier optic will block the incident laser energy and/or the plasma radiation. And, firing of the laser through dirty optics can permanently fuse particulate matter to the optic thus requiring replacement or polishing.

Featured in one example is a handheld LIBS device which does not require argon canisters or an expressive argon regulator. Instead, an inexpensive air pump (e.g., available from Maxclever Electric or Boxer GmbH) has its intake exposed to the atmosphere and pumps an atmospheric gas mixture (e.g., air) to the nose cavity of the LIBS device to keep the barrier optics clean. The need to clean, replace, or polish the barrier optics is thus reduced.

Featured is a handheld LIBS device comprising a laser source for generating a laser beam, a spectrometer subsystem for analyzing a plasma generated when the laser beam strikes a sample, and a nose section including an end plate with an aperture for the laser beam and for receiving plasma radiation and an optic spaced from the end plate defining with the end plate a cavity therebetween. An atmospheric purge subsystem includes an air pump with an intake exposed to the atmosphere and a conduit connected to the air pump providing an atmospheric gas mixture to the nose section cavity to purge the cavity of contaminants and keep the optic clean as the atmospheric gas mixture exits the cavity through the end plate aperture.

In some embodiments, the end plate further includes a vent for removing the atmospheric gas mixture from the cavity. Preferably, there is no inert gas canister and/or gas regulator. The device may further include a filter for the air purge intake.

Also featured is a method comprising generating a laser beam through a transparent optic and an end plate aperture defining a cavity therebetween, analyzing a plasma generated when the laser beam strikes a sample, and while generating the laser beam, providing an atmospheric purge gas mixture to the cavity via an air pump with an intake exposed to the atmosphere and a conduit connected to the air pump providing the atmospheric gas mixture to the nose section cavity to purge the cavity of contaminants and keep the optic clean as the atmospheric gas mixture exits the cavity through the end plate aperture.

A new handheld LIBS device with atmospheric purge features a laser source for generating a laser beam, a spectrometer subsystem for analyzing a plasma generated when the laser beam strikes a sample, and a nose section with an aperture for the laser beam and for receiving plasma radiation. An atmospheric purge subsystem includes an air pump with an intake exposed to the atmosphere and a conduit connected to the air pump providing an atmospheric gas mixture to the nose section to purge the nose section of contaminants as the atmospheric gas mixture exits the nose section. In some versions the nose section includes an end plate with the aperture and a transparent optic spaced from the end plate defining with the end plate a cavity therebetween. The end plate may further include a vent formed therein for removing the atmospheric gas mixture from the cavity.

The subject invention, however, in other embodiments, need not achieve all these objectives and the claims hereof should not be limited to structures or methods capable of achieving these objectives.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIGS. 1A-1B are schematic three-dimensional views showing an example of a handheld LIBS device with a nose section and an end plate;

FIG. 2 is a schematic view showing an example of the primary components of the handheld LIBS device of FIG. 1;

FIG. 3 is a schematic cross-sectional view showing the nose plate cavity of FIG. 2; and

FIGS. 4-6 depict the pump and filter door/housing for an example of the device of FIG. 1A.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

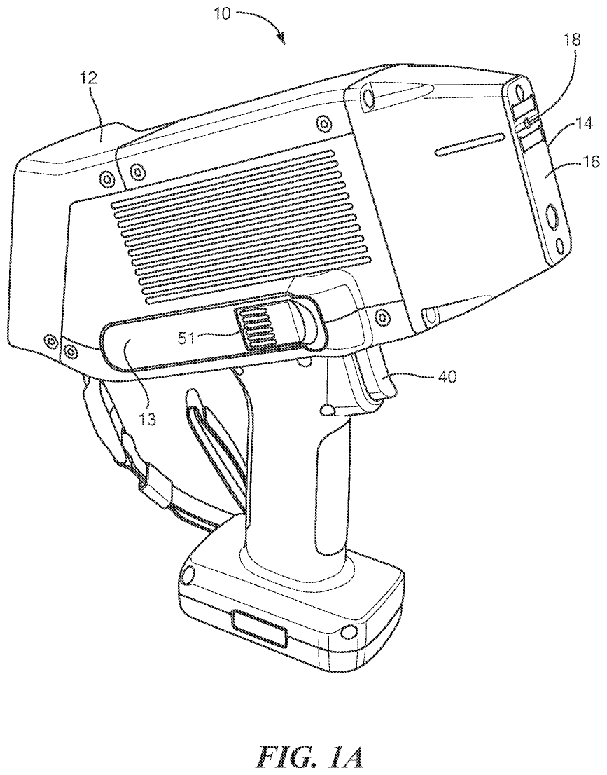

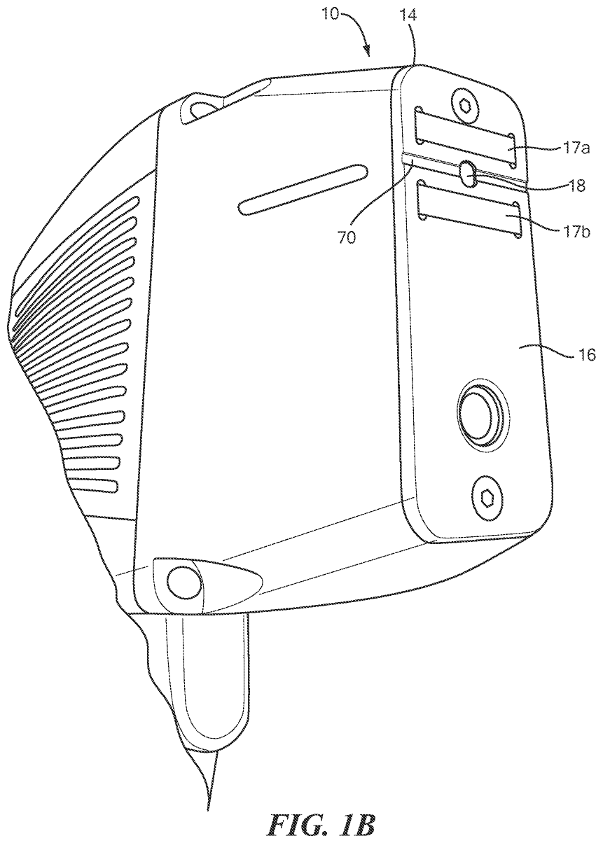

Handheld LIBS device 10, FIGS. 1A-1B in one example, includes housing 12 with nose section 14 terminating an end plate 16 with aperture 18 for the laser beam. Typically, focusing optics focus the laser beam at or proximate the nose plate aperture which is held against the sample to be evaluated. A plasma is created and the photons thereof enter the nose plate aperture to be evaluated by a spectrometer subsystem within housing 12.

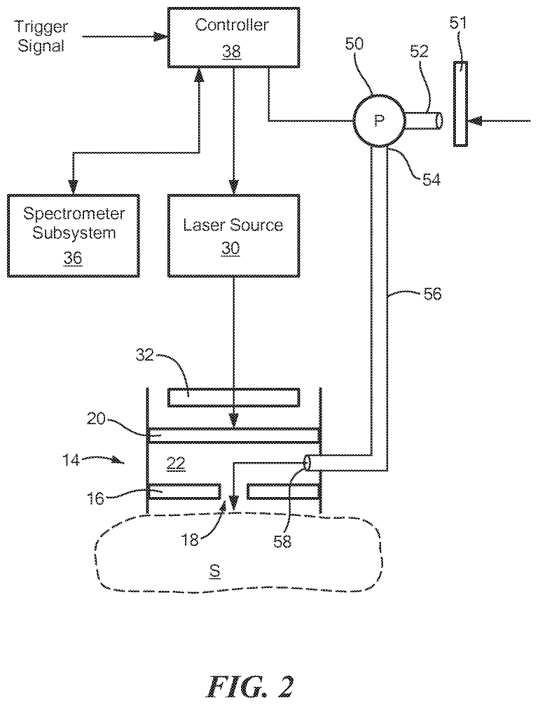

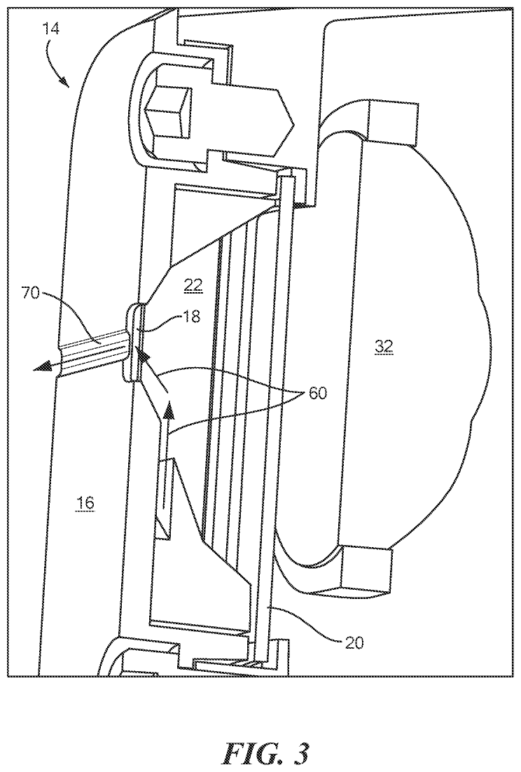

As shown in the example of FIGS. 2-3, preferably, nose section 14 includes apertured end plate 16 spaced from a transparent barrier optic (splatter shield) 20 defining cavity 22 therebetween. End plate 16 is flat and smooth and is shown in FIG. 2 abutting sample S. Laser source 30 provides laser beam 32 focused by focusing lens 32 to a focal point at, in, or proximate sample S after passing through end plate 16 aperture 18. The resulting plasma radiation is detected by spectrometer subsystem 36.

Additional optical components which transmit the laser beam to the sample and which transmit the plasma radiation to the spectrometer subsystem are not shown. But, see U.S. Pat. Nos. 9,719,853; 9,568,430; and 9,036,146 all incorporated herein by this reference. Controller 38 (for example one or more microprocessors or microcontrollers) may control laser source 30 and/or spectrometer subsystem 36 based on a trigger signal from, for example, trigger 40, FIG. 1 which, when pressed by the user, begins a sample analysis routine wherein the laser is fired one or more times and spectral analysis on the resulting plasma is performed.

In this example, transparent shield 20 protects focusing optic 32 and other components in the device housing behind the shield from particulate matter created when the laser strikes the sample.

Featured is an atmospheric (e.g., air) purge subsystem which preferably keeps shield 20 cleaner. In one example, inexpensive air pump 50, FIG. 2 has intake 52 with optional foam filter 51 exposed to the atmosphere (e.g., an air gas mixture). Pump output 54 is connected to a conduit such as conduit 56 which terminates in this example as shown at 58 in cavity 22 (with or without a nozzle) to purge the cavity of contaminants and to keep the shield 20 clean as the atmospheric gas mixture exits the cavity through end plate aperture 18 as shown at 60, FIG. 3.

An argon purge may be useful for detecting some elements in a sample but is not always needed for all applications. Additionally, the argon canisters must be frequently replaced and they and the argon regulator are expensive.

Here, the atmospheric gas mixture purge serves a somewhat different purpose, namely keeping the splatter shield (or other LIES optics) clean so it doesn't have to be withdrawn from the handheld LIES device and cleaned and/or replaced as often. And yet, for many elements, a sufficient signal is still generated with an air purge as opposed to an argon purge. Argon canisters and an expensive argon regulator are not needed or included. Air pump 50, FIG. 2 costs a fraction of an argon regulator.

If the sample surface is smooth, air may not be able to escape the interface between the end plate and the sample. Thus, end plate 16, FIG. 1B may include one or more vents 70 in the form of grooves or the like formed in the end plate outer surface. The only escape path for the flowing air is out through the small hole in the end plate. This small volume is the same region where the plasma is occurring and so the plasma particulate residue is immediately carried out through the hole and then sideways through the grooved vent(s). Rubber anti-skid pads 17a, 17b may also be incorporated onto end plate 16 above and below orifice 18 to keep the end plate on the sample without moving.

Controller 38, FIG. 2, may be configured (e.g., programmed) to energize air pump 50 during the analysis/test cycle. For example, controller 38 may receive a trigger signal to start a test and energize pump 50 before firing laser source 30. After a suitable test time (e.g., after 150 laser shots), controller 38 may be programmed to deenergize pump 50. Alternatively, controller 38 may be configured to deenergize pump 50 when no more spectral data is received from spectrometer subsystem 36. Energizing the air pump only during a test saves battery power.

The positive air flow out of the cavity 22 through end plate 16 orifice 18 prevents particulate matter from entering cavity 22 and contaminating splatter shield 20 which would otherwise affect the transmission of laser energy through the shield and/or the transmission of plasma radiation through the shield to be detected by the spectrometer subsystem.

In other designs, the analyzer includes a nose section purged by the atmospheric (e.g., air) gas but no shield protecting the analyzer optics. For example, various barrier optics (e.g., lenses) may be exposed to the plasma and in such designs the atmospheric purge gas helps clean the optical components to avoid the need for repeated applications of a polishing paste for the lenses.

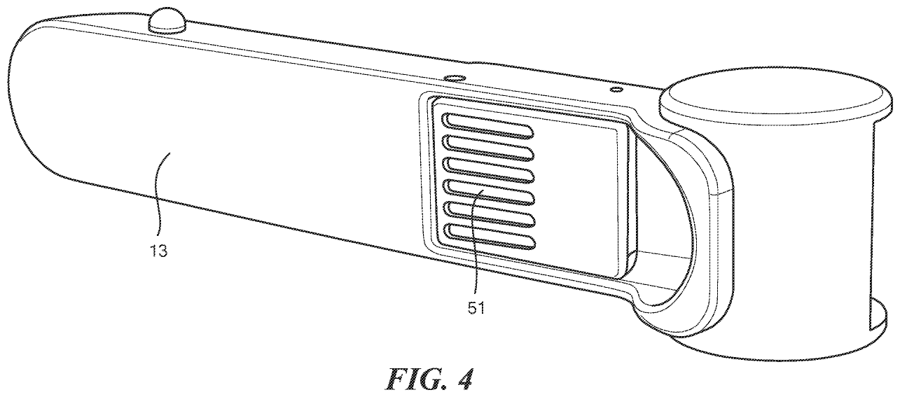

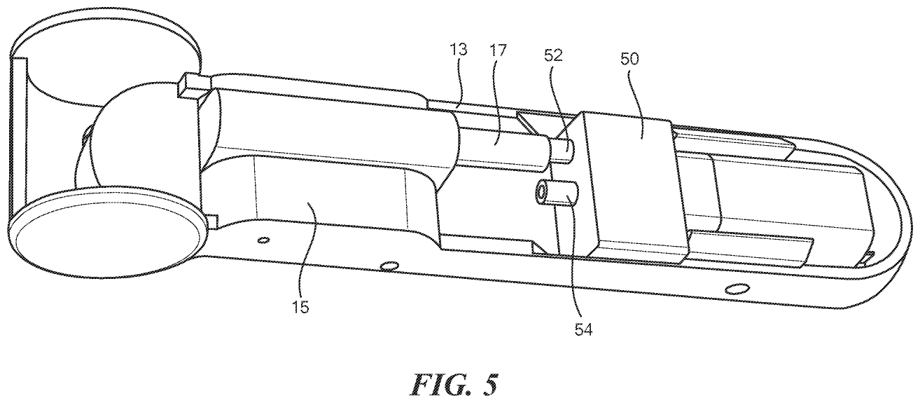

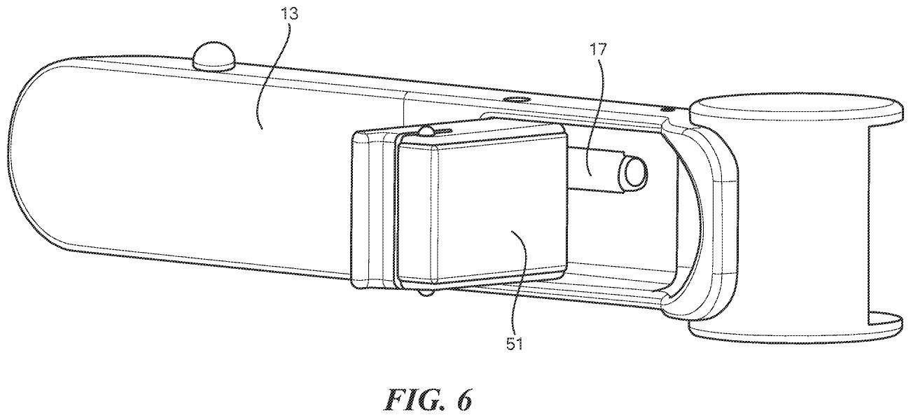

In FIG. 1A, air pump 50, FIG. 2, may be located behind door 13, FIG. 1A in housing 12 and foam filter 51 is behind the openings in the door. See also FIG. 4. In FIG. 5, pump 50 is held by door 13 and has intake 52 connected to the filter housing 15 via conduit 17. FIG. 6 shows the door open to replace filter 51 if needed.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant cannot be expected to describe certain insubstantial substitutes for any claim element amended.

What is claimed is:

1. A handheld LIBS device with atmospheric purge, the device comprising:
a laser source for generating a laser beam;
a spectrometer subsystem for analyzing a plasma generated when the laser beam strikes a sample;
a nose section including:
an end plate with an aperture for the laser beam and for receiving plasma radiation, and
an optic spaced from the end plate defining with the end plate a cavity therebetween; and
an atmospheric purge subsystem including:
an air pump with an intake exposed to the atmosphere, and
a conduit connected to the air pump providing an atmospheric gas mixture to the nose section cavity to purge the cavity of contaminants and keep the optic clean as the atmospheric gas mixture exits the cavity through the end plate aperture.

2. The device of claim 1 in which the end plate further includes a vent for removing the atmospheric gas mixture from the cavity.

3. The device of claim 1 in which there is no inert gas canister and/or gas regulator.

4. The device of claim 1 further including a filter for the air purge intake.

5. A handheld LIBS method comprising:
generating a laser beam through a transparent optic and an end plate aperture defining a cavity therebetween;
analyzing a plasma generated when the laser beam strikes a sample; and
while generating the laser beam, providing an atmospheric purge gas mixture to the cavity via an air pump with an intake exposed to the atmosphere and a conduit connected to the air pump providing the atmospheric gas mixture to the nose section cavity to purge the cavity of contaminants and keep the optic clean as the atmospheric gas mixture exits the cavity through the end plate aperture.

6. The method of claim 5 in which the end plate further includes a vent for removing the atmospheric gas mixture from the cavity.

7. The method of claim 5 in which there is no inert gas canister and/or gas regulator.

8. A handheld LIBS device with atmospheric purge, the device comprising:
a laser source for generating a laser beam;
a spectrometer subsystem for analyzing a plasma generated when the laser beam strikes a sample;
a nose section with an aperture for the laser beam and for receiving plasma radiation; and
an atmospheric purge subsystem including:
an air pump with an intake exposed to the atmosphere, and
a conduit connected to the air pump providing an atmospheric gas mixture to the nose section to purge the nose section of contaminants as the atmospheric gas mixture exits the nose section.

9. The device of claim 8 in which the nose section includes an end plate with the aperture and a transparent optic spaced from the end plate defining with the end plate a cavity therebetween.

10. The device of claim 9 in which the end plate further includes a vent for removing the atmospheric gas mixture from the cavity.
